(19) United States
(12) Patent Application Publication
(10) Pub. No.: US 2026/0001016 A1
(43) Pub. Date: Jan. 1, 2026

(54) POROUS STRUCTURE SUCH AS FOR FILTERS, AND MAKING THE SAME

(71) Applicant: CORNING INCORPORATED, CORNING, NY (US)

(72) Inventors: Guohua Chen, Painted Post, NY (US); Weimin Hou, Shanghai (CN); He Jing, Clayton, MO (US); Jia Liu, Painted Post, NY (US); Yiting Qin, Shanghai (CN); John Forrest Wight, Jr., Corning, NY (US); Qing Zhou, Shanghai (CN)

(21) Appl. No.: 18/880,668

(22) PCT Filed: Jul. 11, 2023
(86) PCT No.: PCT/US2023/027343

§ 371 Date: Jan. 2, 2025

(30) Foreign Application Priority Data
Jul. 15, 2022 (CN) 202210837119.9

(51) Int. Cl. B01D 39/20; B01D 46/10; B01D 46/24; C03B 19/06; C03C 3/091; C03C 11/00

(52) U.S. Cl. CPC B01D 39/2003; B01D 46/10; B01D 46/2482; B01D 46/2484; C03B 19/06; C03C 3/091; C03C 11/002; C03C 11/007; B01D 2239/10; B01D 2239/1208

(57) ABSTRACT

A method of making a porous structure configured for use in a particulate filter includes bonding a plurality of glass bubbles to one another, and breaching the plurality of glass bubbles. Voids within individual breached glass bubbles open into one another to form cavities that extend through the porous structure.

### CROSS-REFERENCE TO RELATED APPLICATIONS

This application claims the benefit of priority under 35 U.S.C. § 119 of Chinese Patent Application Serial No. 202210837119.9 filed on Jul. 15, 2022, the content of which is relied upon and incorporated herein by reference in its entirety.

### BACKGROUND

### Field

The present disclosure generally relates to filter materials, more specifically, to porous structures made from hollow glass bodies that have been breached, and which may be used with filters.

### Technical Background

The amount of CO₂ in atmosphere has steadily increased since the Industrial Revolution due to fossil fuel combustion technologies like coal-fired power plants and gasoline/diesel based automobiles. As such CO₂ increase, the global warming concern is raised and so is the understanding that countries need to control CO₂ emission or to capture CO₂.

To combat its detrimental effects, CO₂ can be reduced and/or captured or at directly in air or at the v sources (e.g., power plants) before CO₂ is released to the environment.

In the last few decades, ceramic honeycomb wall flow filters have been developed and integrated into engine after-treatment systems to capture fine particulates from diesel and gasoline engine exhausts. These are generally Cordierite-based and have been engineered to withstand high temperatures (800° C. or higher) and high thermal shocks. For CO₂ capture from ambient air of flue gas, such properties are not necessary, and it is desirable to develop low-cost honeycomb filters with properties and performance optimized for CO₂ capture application.

Tiny glass bubbles, also called microballoons or hollow glass “microspheres,” are commercially available, such as from Dennert Poraver GmbH, 3M, Zhongke Yali Technology, Ltd, Fibre Glast Developments Corp., Potters Industries LLC, and others. Such glass bubbles may be used as filler in composite materials, such as concrete.

Glass bubbles can be characterized by “diameter,” where diameter refers to the diameter if volume of the glass bubble was arranged in a perfect spherical geometry. In practice, however, glass bubbles may only be generally spherical, such as having a potato-shape, for example. The size of glass bubbles may be selected and characterized based on the diameter, where “D50” particle size corresponds to a 50% pass point of glass bubbles having a diameter of the D50 value, where half in a group are larger and half are smaller in diameter than the D50 value. Likewise, “d50” corresponds to a 50% pore size of a porous structure, and d10 corresponds to a 10% pass point, as measured by ASTM standard with mercury intrusion. Accordingly, the ratio of df=(d50-d10)/d50 provides insight into pore size distribution—the smaller the ratio, the narrower the pore size distribution.

Glass bubbles are generally fragile and conventional practices teach methods to prevent breakage of the glass bubbles so as to maintain internal closed cavities of the glass bubbles, preserving the correspondingly low weight-to-volume relationships that glass bubbles may provide. When integrity of the glass bubbles is maintained, the glass bubbles may be integrated in composite materials for buoyant, load-bearing structures, such as surf boards or supports for offshore drilling equipment.

### SUMMARY

Despite their conventional uses, Applicants discovered glass bubbles may be arranged and processed to make particularly efficient porous structures with open porosity, such as for filters. Structures with open porosity may be formed from tightly packing glass bubbles together, bonding the glass bubbles to one another and also breaching (e.g., breaking, popping, fracturing, opening, exposing hollow cores thereof) the glass bubbles. Voids of the individual glass bubbles open into one another to form porous cavities that extend and interconnect through the overall structure and may open to surfaces thereof. Such structures may be particularly useful with filters, or may be used for other purposes, such as providing a glass skeleton infiltrated with polymer, for example.

According to some embodiment a porous structure, comprises:
a plurality of glass bubbles comprising at least 7.3 wt % Na₂O;
wherein the glass bubbles are sintered to one another such that adjoining glass bubbles are physically bonded directly to one another;
wherein more than 50% of the glass bubbles are breached;
wherein voids defined within individual breached glass bubbles open into one another to form cavities that extend through the porous structure and to surfaces thereof; and
wherein the porous structure has at least 50% porosity in terms of volume and comprises at least 10 vol % MgO.

According to some embodiments the porous structure comprises at least 10 vol % of MgO, and glass bubbles comprise glass with at least 10 wt % Na₂O. According to some embodiments the porous structure comprises glass bubbles comprising glass with at least 20 wt % of Na₂O. According to some embodiments the porous structure comprises 10 vol % to 15 vol % MgO and glass with 15 wt % to 30 wt % Na₂O. According to some embodiments the porous structure comprises glass bubbles comprising glass comprising 10 wt % to 20 wt % of Na₂O.

According to some embodiments of the porous structure more than 60% of the glass bubbles are breached. According to some embodiments, the porous structure has at least 55% porosity in terms of volume, for example at least 60% porosity in terms of volume, at least 70% porosity in terms of volume, or at least 75% porosity in terms of volume. According to some embodiments, the porous structure has at least 60% to 95% porosity in terms of volume. According to some embodiments, the porous structure has at least 65% and no more than 85% porosity in terms of volume.

According to some embodiments at least some glass of the glass bubbles is devitrified such that the glass comprises crystals. According to some embodiments, in terms of weight, the porous structure comprises mostly of glass. According to some embodiments, in terms of weight, the porous structure comprises >50% of glass. According to some embodiments, in terms of weight, the porous structure is >50% crystalline.

According to some embodiments, in terms of weight, the porous structure comprises at least 90% of glass. According to some embodiments, in terms of weight, the porous structure comprises less than 75% of amorphous-phase glass.

According to some embodiments the porous has a cellular honeycomb geometry with a web thickness of no more than 10 mils and a cell density of no more than 400 cells per square inch.

According to some embodiments a method of making a porous structure configured for use in a particulate filter comprises:
adding a source Mg to a plurality of glass bubbles comprising Na₂O;
heating and bonding the plurality of glass bubbles to one another, wherein the glass bubbles have a D50 particle size of at least 1 micrometer but no more than 100 micrometers, and wherein the plurality comprises at least 1000 of the glass bubbles; and
breaching at least some of the glass bubbles at a temperature between 500° C. and 800° C.;
wherein, in aggregate, the bonded, breached glass bubbles form the porous structure, the porous structure comprising at least 10 wt % Na₂O and at least 10 wt % MgO, and wherein voids within individual breached glass bubbles open into one another to form cavities that extend through the porous structure and to surfaces thereof.

According to some embodiments a method of making a porous structure configured for use in a particulate filter comprises:
adding a source Mg to a plurality of glass bubbles comprising Na₂O;
heating and bonding the plurality of glass bubbles to one another, wherein the glass bubbles have a D50 particle size of at least 1 micrometer but no more than 100 micrometers, and wherein the plurality comprises at least 1000 of the glass bubbles; and
breaching at least some of the glass bubbles at a temperature between 500° C. and 800° C.;
wherein, in aggregate, the bonded, breached glass bubbles form the porous structure, the porous structure comprising at least 10 vol % MgO and glass comprising at least 7.3 wt % Na₂O, and wherein voids within individual breached glass bubbles open into one another to form cavities that extend through the porous structure and to surfaces thereof.

According to some embodiments of method, the heating step is performed at a peak temperature that is less than 900° C.

According to some embodiments a method of making a porous structure configured for use in a particulate filter, comprises:
adding a source MgO to a plurality of glass bubbles comprising Na₂O;
heating and bonding the plurality of glass bubbles to one another, wherein the glass bubbles have a D50 particle size of at least 1 micrometer but no more than 100 micrometers, and wherein the plurality comprises at least 1000 of the glass bubbles; and
breaching at least 50% of the glass bubbles at a temperature between 500° C. and 800° C. (e.g., between 600° C. and 770° C.);
wherein, in aggregate, the bonded, breached glass bubbles form the porous structure, the porous structure comprising at least 10 vol % MgO and glass comprising at least 10 wt % Na₂O (e.g., at least 15 wt % Na₂O, and
wherein voids within individual breached glass bubbles open into one another to form cavities that extend through the porous structure and to surfaces thereof.

According to some embodiments of the method, in aggregate, the bonded, breached glass bubbles form the porous structure, the porous structure comprising at least 20 wt % Na₂O and 10 wt % to 15 wt % MgO.

According to some embodiments the method comprises devitrifying at least some glass of the glass bubbles to form crystals. According to some embodiments the breaching step includes flowing amorphous glass of the glass bubbles relative to the crystals.

According to some embodiments the heating is such that adjoining glass bubbles sinter to one another. According to some embodiments breaching occurs concurrently with the heating.

According to some embodiments, the method further comprises cooling the plurality of glass bubbles with the adjoining, breached glass bubbles physically bonded directly to one another.

According to some embodiments of the method may further comprising, prior to the heating, extruding green material comprising the glass bubbles and an organic binder, wherein most of the glass bubbles survive the extruding without fracturing. According to some embodiments the extruding comprises extruding thousands of the glass bubbles coupled to one another with the organic binder. According to some embodiments the heating burns out or chemically changes most of the organic binder in terms of weight.

According to some embodiments the bubbles have a D50 particle size of at least 1 micrometer but no more than 100 micrometers, e.g., at least 5 micrometer but no more than 25 micrometers, or at least 10 micrometer but no more than 20 micrometers.

According to some embodiments of the method, the heating is such that adjoining glass bubbles sinter to one another. According to some embodiments breaching occurs concurrently with the heating.

According to some embodiments the method of making a porous structure further comprises cooling the plurality of glass bubbles with the adjoining, breached glass bubbles physically bonded directly to one another.

According to some embodiments, the method of making a porous structure further comprises, prior to the heating, extruding green material comprising the glass bubbles and an organic binder, wherein most of the glass bubbles survive the extruding without fracturing.

According to some embodiments, the method of making a porous structure comprises extruding thousands of the glass bubbles coupled to one another with the organic binder.

According to some embodiments, the method of making a porous structure the heating burns out or chemically changes most of the organic binder in terms of weight.

Other exemplary embodiments include a method of making a porous structure that includes steps of extruding green material, which includes glass bubbles and an organic binder, where most of the glass bubbles survive the extruding without fracture, but then breaching most of the glass bubbles after the extruding and bonding the plurality of glass bubbles to one another. In aggregate, the bonded, breached glass bubbles form the porous structure. In some embodiments, during the extruding, the glass bubbles have a D50 size of at least 1 micrometer but less than 100 micrometers, such as a D50 size of at least 5 micrometers and no more than 50 micrometers, or 5 micrometers to 25 micrometers. In some embodiments, after the breaching, the porous structure comprising the breached glass bubbles have a pore size distribution (d50-d10)/d50 of less than 0.8. In some embodiments, during the extruding, the glass bubbles have an isostatic crush strength of 1000 psi or higher. In some embodiments, during the extruding, most of the glass bubbles have a density of at least 0.1 g/cm3 but less than 1.5 g/cm3. In some embodiments, during the extruding, the glass of the glass bubbles is soda lime, borosilicate, and/or aluminum silicate.

Still other exemplary embodiments include a method of making a porous structure including steps of extruding green material, which includes glass bubbles and an organic binder, where most of the glass bubbles survive the extruding without fracture; heating the glass bubbles to at least a softening temperature of amorphous glass of the glass bubbles; breaching most of the glass bubbles after the extruding, wherein the breaching includes expanding gasses within the glass bubbles to rupture the glass bubbles; bonding the glass bubbles to one another, wherein the heating is such that adjoining glass bubbles sinter to one another, for example at temperatures of 550° C. to 870° C., for example 550° C. to 800° C., or 550° C. to 700° C. In aggregate, the bonded, breached glass bubbles form the porous structure, where voids within individual breached glass bubbles open into one another to form cavities that extend through the porous structure and to surfaces thereof. In some such embodiments, the extruded green material floats in water, while the porous structure, which includes the bonded, breached glass bubbles, sinks.

In some embodiments a porous structure includes a plurality of glass bubbles. The glass bubbles are sintered to one another such that adjoining glass bubbles are physically bonded directly to one another. Most of the glass bubbles are breached and voids defined within individual breached glass bubbles open into one another to form cavities that extend through the porous structure and to surfaces thereof. The porous structure has at least 50% porosity in terms of volume. In some such embodiments, at least some of the glass of the glass bubbles is devitrified such that the glass includes crystals. In some embodiments, the porous structure is mostly glass (including devitrified glass), in terms of weight, such as at least 90% of glass, and/or where less than 75% of the porous structure is amorphous phase in terms of weight. In some embodiments, the porous structure has at least 65% and no more than 85% porosity in terms of volume.

In other embodiments a porous structure is mostly (e.g., at least 90%), in terms of weight, a plurality of ruptured glass bubbles sintered to one another such that adjoining glass bubbles are physically bonded directly to one another. Voids defined within individual ruptured glass bubbles open into one another to form cavities that extend through the porous structure and to surfaces thereof. In some such embodiments, the porous structure has a cellular honeycomb geometry with a web thickness of no more than 9 mils, preferably no more than 8 mils, more preferably no more than 6 mils, and a cell density of at most 300 cells per square inch, preferably at most 200 cells per square inch. Other embodiments include a filter that includes such a porous structure and further includes a coating supported by the porous structure, where the coating may be configured to block and/or attract target particulates (i.e. particulate filter), and a housing at least in part surrounding the porous structure and coating,

Still other embodiments include extrusion batch material for making porous structures, which includes a plurality of glass bubbles, where the glass bubbles have a D50 size of at least 1 micrometer and no more than 100 micrometers, and where the glass bubbles have an isostatic crush strength of 1000 psi or higher. The extrusion batch further includes a binder and has a specific gravity with respect to water of less than 1.0. In some embodiments, the extrusion batch further includes a pore former, such as an organic pore former, such as a starch. In some embodiments glass bubbles have a D50 size of at least 5 micrometer and no more than 50 micrometers. In some embodiments glass bubbles have a D50 size of at least 10 micrometer and no more than 25 micrometers, or at least 10 micrometer and no more than 20 micrometers.

Still other embodiments include a porous structure that may be a filter substrate or body (e.g., honeycomb) or may serve other purposes, such has providing support for liquid electrolyte or a skeleton to be infiltrated with a polymer. The structure includes a plurality of glass bubbles having a D50 size of less than 100 micrometers. The glass bubbles are sintered to one another such that adjoining glass bubbles are physically bonded directly to one another. Most of the glass bubbles are breached, and voids defined within individual breached glass bubbles open into one another to form cavities that extend through the structure and to surfaces thereof. In some embodiments, at least some of the glass of the glass bubbles is devitrified such that the glass includes crystals.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary and are intended to provide an overview or framework to understand the nature and character of the claims.

### BRIEF DESCRIPTION OF THE FIGURES

The accompanying Figures are included to provide a further understanding and are incorporated in and constitute a part of this specification. The drawings illustrate one or more embodiments, and together with the Detailed Description explain principles and operations of the various embodiments. As such, the disclosure will become more fully understood from the following Detailed Description, taken in conjunction with the accompanying Figures, in which:

FIG. 1 is a perspective view of a porous structure, such as honeycomb body, as may embody technology disclosed herein.

FIG. 2 is a perspective view of another structure as may embody technology disclosed herein.

FIGS. 3 and 4 are micrographs of exemplary green structures that include exemplary glass bubbles.

FIG. 5 are micrographs of a glass bubble morphology transformations, after the green structure similar to that shown in FIGS. 3 and 4 was heated to various temperatures, and illustrates that at some firing temperatures the glass bubbles ruptured and devitrified, according to an exemplary embodiment.

FIG. 6 further illustrates the firing temperature impact on the changes in the structure shown in FIG. 5.

FIG. 7 are micrographs of a comparative structure containing glass bubbles comprising no Mg and 20 wt % Na₂O.

FIG. 8 are micrograph of structures resulting from heating the green structure containing glass bubbles comprising 20 wt % Na₂O and a significant amount of MgO, and illustrates that at some firing temperatures the glass bubbles ruptured and devitrified at relatively low temperatures, according to another exemplary embodiment.

FIG. 9 further illustrates the firing temperature impact on the changes in the structure(s) shown in FIG. 8, and presence of crustal phases in the structure(s).

FIG. 10 are micrograph of structures resulting from heating the green structure containing glass bubbles comprising 30 wt % Na₂O and a significant amount of MgO, and illustrates that at the glass bubbles ruptured and devitrified at relatively low firing temperatures, according to another exemplary embodiment.

FIG. 11 further illustrates the firing temperature impact on the changes in the structure shown in FIG. 10.

### DETAILED DESCRIPTION

Before turning to the following Detailed Description and Figures, which illustrate exemplary embodiments in detail, it should be understood that the present inventive technology is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

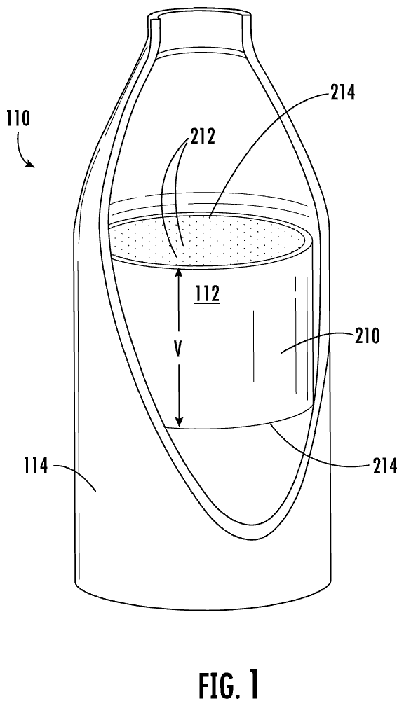

Referring to FIG. 1, a porous structure 210 may be used in a filter 110 or otherwise. The porous structure 210 is a “honeycomb” in that the porous structure 210 includes elongated channels 212 that extend generally through at least a portion of the porous structure 210, such as extending linearly from an outer surface 214 (e.g., face) of the porous structure 210 to or near an opposing outer surface of the porous structure 210. In some embodiments, some or all of the elongated channels 212 are unplugged, allowing fluids to flow through the elongated channels 212. In still other embodiments, the porous structure may be porous but not include elongate channels 212.

According to an exemplary embodiment, the elongate channels 212 may have relatively high aspect ratios, such as length-to-width or length-to-diameter, where length L is oriented along the flow path of the elongate channels 212, between openings on the outer surface 214 provided by the elongate channels 212 on opposing outer surfaces 214 of the porous structure 210, as shown in FIG. 1. According to an exemplary embodiment, elongate channels 212 are elongate such that the aspect ratio, defined as the length of an elongate channel 212 in relation to widest cross-sectional dimension of the respective elongate channel 212 orthogonal to the length L, of at least some of (e.g., most, or >90%, or all) the channels is at least ten, at least twenty, at least fifty, at least one-hundred, and/or no more than 50,000.

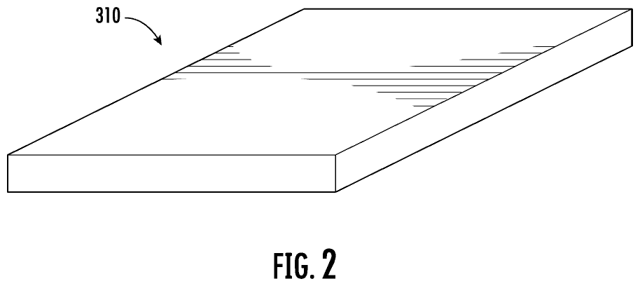

While FIG. 1 shows porous structures 210 having a generally cylindrical geometry, other geometries are contemplated, such as cube, box, sheet, and more complex geometries. For example, referring now to FIG. 2, the porous structure 310 is generally a rectilinear sheet, which may be used as a filter substrate or for other purposes. In some embodiments, the structure 310 of FIG. 2 has a generally uniform density and heterogeneous pore distribution, essentially a sheet of glass foam, without elongate channels. The foam may be highly porous, coated, and/or partially- or fully-filled with liquid material (e.g., electrolyte), solid material (e.g., dielectric), or otherwise.

According to an exemplary embodiment, the structure 310 is highly porous, and the pores (e.g., cavities, voids, space between structure) are open to one another such that fluids may pass through the pores, into and through the structure 310. However, the structure 310 may be only semi-permeable, in some such embodiments, allowing only some fluids and/or smaller particulates to pass through the structure 310, but trapping or blocking others.

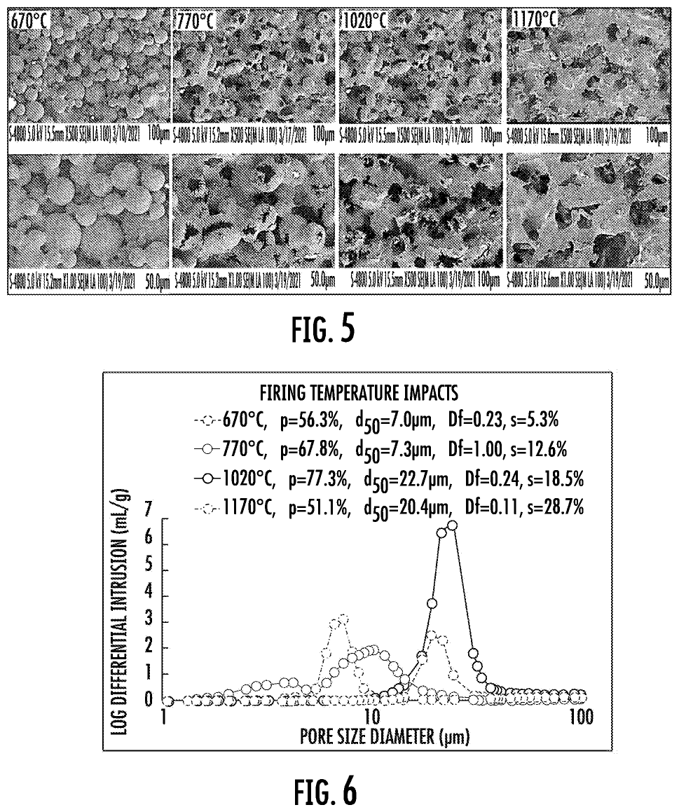

According to an exemplary embodiment, structures, such as the porous structures 112, 210 and structure 310 of FIGS. 1-2, may include and/or be at least partially formed from a plurality of glass bubbles (e.g., hollow microspheres, see for example, glass bubbles 512, 512′ of FIG. 5), where “plurality” may include more than 100, such as more than 1000. In some such embodiments, the glass bubbles have a D50 size of at least 1 micrometer (μm) and no more than 1000 μm, such as at least 5 μm, at least 25 μm, and/or no more than 500 μm, such as no more than 250 μm, such as no more than 100 μm, as per ASTM standards, such as D4284-12. In some such embodiments, the porous structures including the glass bubbles have a pore size distribution df=(d50-d10)/d50 of less than 0.8, such as less than 0.4, such as less than 0.2, such as less than 0.1, such as less than 0.06. In some such embodiments, most of the glass bubbles (prior to breach, as discussed below) have a density of at least 0.1 g/cm³, such as at least 0.3 g/cm³, and/or less than 1.5 g/cm³, such as less than 0.7 g/cm³, where density accounts for mass per volume, including interior bubble volume.

According to an exemplary embodiment, the porous structures 210, 310, in terms of weight, are mostly glass or crystallized glass (glass-ceramic, ceramic), such as at least 70% of the weight, such as at least 80%, and such as at least 90%. Such large portions of the structures 210, 310 formed from glass or crystallized glass of glass bubbles may be surprising or counterintuitive for those in industry because they may expect such structures to be particularly fragile and/or not hold together at all. However, in some contemplated uses, porous space of the porous structures 210, and structure 310 may later be at least partially filled by other materials (e.g., sorbents for CO₂ capture), while the porous structures 210 and structure 310 largely hold together due to methods of making such structures as taught herein.

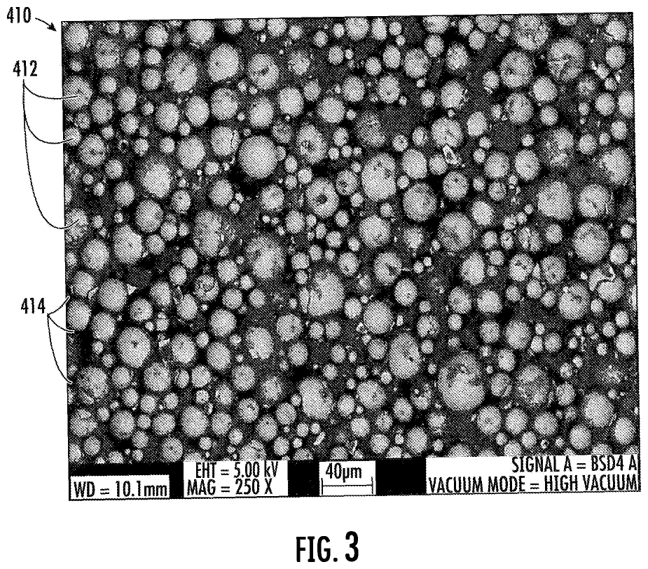

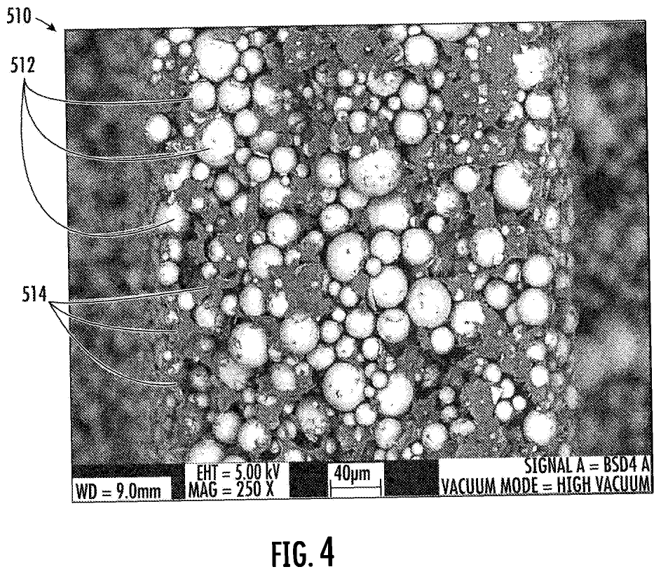

FIGS. 3-4 include “green” (e.g., pre-fired, pre-sintered) structures 410, 510. More specifically, green structure 410 of FIG. 3 may be an exterior wall of a porous structure, such as a honeycomb porous structure as shown in FIG. 1. While green structure 510 of FIG. 4 may be an interior wall or web of a porous structure, such as a honeycomb body.

The green structures may be formed from extruded batch material. According to an exemplary embodiment, the green structures 410, 510 include glass bubbles 412, 512 held in binder 414, 514 (e.g., organic binder, or mostly-organic binder). Preferably, the glass bubbles are hollow, and have thin walls. This allows the bubbles to rupture when heated, resulting in high porosity structures. In some embodiments, the batch material may include glass bubbles of particle size 3 to 100 micrometers, such as having a particle distribution of (D90-D10)/D90 less than 2, such as less than 1.5, or less than 1. According to some embodiments, the particle distribution Df=(D50-D10)/D50, and Df is less than 2, such as less than 1.5, or less than 1.

According to an exemplary embodiment, the batch density (e.g., “wet batch” density) is less than 1.5 g/cm³, such as less than 1.0 g/cm³, such as less than 0.5 g/cm³, such as less than 0.3 g/cm³. According to an exemplary embodiment, the green material and batch material float (i.e. specific gravity less than 1, compared to water) of FIGS. 3-4, while finished porous structures, after firing and/or breaching of the glass bubbles, may sink.

In some embodiments, the green structures 410, 510 may further include a slip agent and/or lubricant, such as oil. Sodium stearate or another sintering aid may be added to the batch. In some embodiments, the binder may include methylcellulose. In some embodiments, the batch may further include a pore former, such as an organic pore former, such as a starch (e.g., corn starch, pea starch). According to an exemplary embodiment, glass bubbles 412, 512 may be a “stand-alone” composition in terms of the inorganic constituents (>90% wt of inorganics in the batch, or >95% wt, skeleton (i.e., packed inorganic particles)). In other embodiments, the batch may further include a second inorganic material with a softening temperature greater than the glass bubbles, such as clay, talc, silica, alumina, minerals, synthetic oxides, other types of glass or ceramic particles and/or bubbles.

In some embodiments, particularly resilient glass bubbles 412, 512 are used, such as those having a mean isostatic crush strength of at least 1000 psi, such as at least 2000 psi, such as at least 3000 psi (see Measuring Isostatic Pressing Strength of Hollow Glass Microspheres by Mercury-injection Apparatus by Yun and Shou, Key Engineering Materials, vol. 544, pp. 460-5 (2013)). Also, rates and pressures through the corresponding extruder may vary depending upon the size of the glass bubbles, their material, and the extruding device. In some embodiments, extrusion pressures are in the range of less than 2500 psi, such as less than 2000 psi, and/or at least 500 psi.

According to an exemplary embodiment, the glass bubbles 412, 512 in binder 414, 514 have been extruded (e.g., twin-screw) at a rate and pressure to preserve integrity of most (e.g., more than 50%, more than 75%, more than 90%) of the glass bubbles 412, 512. As shown in FIGS. 3-4 most of the glass bubbles 412, 512 appear fully intact. With that said, in other contemplated embodiments, extrusion rate and pressure may preserve integrity of many of the glass bubbles, but not most, such as less than 50%, but at least 25%, or at least 20%. Preserving integrity of the glass bubbles 412, 512 allows the glass bubbles to occupy relatively large volumes of space within the green structures 410, 510 with voids between the glass bubbles 412, 512 and within the glass bubbles 412, 512.

Extruding the green structures 410, 510 may be particularly efficient for forming through-channels (e.g., elongate channels 212 as shown in FIG. 1) in porous structures such as the honeycomb of FIG. 1, or other regular features in the respective green structures 410, 510. However, in other contemplated embodiments, such structures, including glass bubbles in binder may be molded, tape-cast, or otherwise shaped or processed, which may better or alternatively preserve integrity of the glass bubbles 412, 512. In still other contemplated embodiments, structures with shapes far different from those of porous structures 112, 210, such as the structure 310, may be extruded or otherwise formed.

The glass bubbles 412, 512 may include glass (e.g., soda lime glass, borosilicate, aluminosilicate glass, or other glasses). The glass of the glass bubbles 412, 512 may be fully or partially amorphous, crystalline, polycrystalline, etc., such as two-phase glass-ceramic. In some embodiments, the glass of the glass bubbles 412, 512 may be amorphous prior to heating, and subsequently may devitrify and/or crystallize. For clarity, “glass” as used herein includes amorphous glass, devitrified glass with crystals, such as glass-ceramic and crystalline phase. In at least some contemplated embodiments, the glass bubbles 412, 512 may include and/or be formed form other materials, such as synthetic minerals, polymers, ceramics, fly ash/cenospheres, metals, etc.

According to an exemplary embodiment, the green structures 410, 510 are heated (e.g., fired in a furnace, laser heated). Heating may burn out, char, chemically transform, or otherwise influence the binder 414, 514. According to an exemplary embodiment, the green structures 410, 510 are heated at least to a softening temperature of glass of the glass bubbles 412, 512. However, the glass bubbles 412, 512 are not overheated, such as well above a liquidus temperature where the glass bubbles 412, 512 may fully lose cohesion or structure. Depending upon the materials, and the required porosity of the resultant structure (e.g., honeycomb filter), the peak heating temperature may be at least 500° C., at least 550° C., at least 600° C., at least 700° C., and/or no more than 1025° C., such as no more than 1020° C., such as no more than 1000° C., such as no more than 900° C., such as no more than 870° C., or no more than 850° C. Depending upon the materials, the peak heating temperature may be, for example, between 500° C. and 1000° C., between 550° C. and 900° C., between 550° C. and 870° C., between 550° C. and 850° C., between 575° C. and 870° C., between 575° C. and 850° C., or between 600° C. and 770° C. The peak heating temperature may be, for example, between 600° C. and 900° C., between 600° C. and 875° C., between 600° C. and 870° C., or between 600° C. and 850° C. In some embodiments the peak heating temperatures will sinter the glass bubbles to one another. In contemplated embodiments, the glass bubbles 412, 512 may have other softening temperatures. After sintering, the resultant structure has a porosity (by volume) that is >50%, for example ≥55%, or ≥60%, or between 60% and 90%. We discovered that lower peak heating temperatures result in advantageously low shrinkage rates s, (s≤10%, and even ≤5%) and high porosity, while saving costs due to lower energy consumption.

According to an exemplary embodiment, conditions and handling of the green structures 410, 510 during the heating is such that adjoining glass bubbles 412, 512 physically interact with one another, such as directly bond to one another (e.g., sinter, weld, melt-into), but without fully losing their individual structures. Put another way, in at least some such embodiments, the conditions and handling are such that the glass bubbles 412, 512 do not fully liquify and/or completely lose structure, and instead become bonded to one another such that, in the aggregate, the resulting structure is cohesive and rigid.

According to a further such exemplary embodiment, conditions and handling of the green structures 410, 510 during the heating may be such that many (e.g., most, >60%; >70%, >75%, >80%, >90%, >95%, or >99%) of the glass bubbles 412, 512 breach or break, such as by rupture from internal gas expansion and/or by devitrification or otherwise. In some such embodiments, the glass bubbles 412, 512 are heated to a point that the glass bubbles 412, 512 lose integrity and glass of the glass bubbles 412, 512 shatters or is otherwise breached. In other contemplated embodiments, the glass bubbles may be breached by microwaves, sound, or other phenomena.

Breaching the glass bubbles 412, 512 may be counterintuitive to those in industry, where glass bubbles may be relied upon to provide buoyancy and/or prevent inflow of materials into voids within the glass bubbles or through the glass bubbles. However, Applicants have found that by breaching the glass bubbles 412, 512 of structures, as disclosed herein, voids of the glass bubbles 412, 512 may be maintained and/or even enlarged and joined to one another.

Following heating, the green structures 410, 510 may be cooled, such as to a temperature at least 100° C. less than the temperatures to which the green structures 410, 510 were heated, such as to less than 100° C., such as less than 50° C. During the cooling, the adjoining glass bubbles 412, 512, which may be less spherical at this point, are and/or remain physically bonded to one another, such as directly or indirectly bonded, with intermediate bonding agents. In some such embodiments, the cooling includes dwelling at temperatures above room temperature (e.g. at the annealing point of the glass of the glass bubbles), but below the heating temperature. Dwelling may occur at incremental steps, in some embodiments, or may be in the form of very gradual temperature declines within certain temperature ranges in other embodiments, both of which may allow for formation of crystals in the materials of the glass bubbles 412, 512, and/or may facilitate relaxing of residual stresses by annealing.

In some embodiments, during heating, the glass bubbles may be heated from ambient temperature to a first temperature(s) (e.g., fixed temperature and/or temperatures in a limited range) with a first dwell time, such as where the first temperature(s) is 300° C. to 400° C., and/or where the first dwell time is at least 1 minute, such as from 1 to 10 hours. In some embodiments the first dwell time is 4-6 hours. In some such embodiments, the temperature is then increased from the first temperature to a second temperature(s) with a second dwell time, such as where the second temperature(s) is greater than 400° C., such as from 550° C. to 900° C., 500° C. and 800° C., 550° C. to 800° C., or even 550° C. to 700° C.) to facilitate bubble rupture and desired crystallization, where the second dwell time is also at least 1 minute, such as from 1 to 10 hours. In some embodiments the second dwell time is 1-3 hours, for example about 2 hours. This process advantageously results in lower shrinkage, for example at a rate s, where s<10%, or even s≤5%, and helps reduce cracking formation of the final structure during cooling. Preferably the second temperature is the peak heating temperature. The parameter s is used to measure the shrinkage, or dimensional change during firing, where s=(Lgreenbody-Lfiredbody)/Lgreenbody, where Lgreenbody is the length of the green body (green structure before it was fired, and Lfiredbody is the length of the resultant porous structure after firing (i.e., after being subjected to the second (peak) heating temperature).

According to some embodiments a method of making a porous structure comprises:
adding a source Mg to a plurality of glass bubbles comprising Na₂O;
heating and bonding the plurality of glass bubbles to one another, wherein the glass bubbles have a D50 particle size of at least 1 micrometer but no more than 100 micrometers, and wherein the plurality comprises at least 1000 of the glass bubbles; and
breaching at least some of the glass bubbles (e.g., >50%, or >55%, or >60%) at a temperature between 500° C. and 800° C. (e.g., (e.g., between 550° C. and 750° C., or between 550° C. and 700° C.), or between 600° C. and 750° C.);
wherein, in aggregate, the bonded, breached glass bubbles form a porous structure, the porous structure least 10 vol % MgO and glass bubbles comprising at least 10 wt % Na₂O, and wherein voids within individual breached glass bubbles open into one another to form cavities that extend through the porous structure and to surfaces thereof.

According to some embodiments the heating step is performed at a peak temperature that is less than 900° C., for example≤870° C., ≤800° C., or ≤770° C.

According to some embodiments the porous structure comprises at least 10 vol % MgO and glass bubbles comprising at least 15 wt % Na₂O, wherein voids within individual breached glass bubbles open into one another to form cavities that extend through the porous structure and to surfaces thereof. According to some embodiments the bonded, breached glass bubbles form the porous structure, the porous structure comprising at least 10 vol % to 15 vol % MgO and glass bubbles comprising 7.3 wt % to 30 wt % Na₂O. According to some embodiments the bonded, breached glass bubbles form the porous structure, the porous structure comprising at least 10 vol % to 15 vol % MgO and glass bubbles comprising 8 wt % to 30 wt % Na₂O. According to some embodiments the bonded, breached glass bubbles form the porous structure, the porous structure comprising at least 10 vol % to 15 vol % MgO and glass bubbles comprising 8.5 wt % to 25 wt % Na₂O. According to some embodiments the bonded, breached glass bubbles form the porous structure, the porous structure comprising at least 10 vol % to 15 vol % MgO and glass bubbles comprising 9 wt % to 20 wt % Na₂O. According to some embodiments the bonded, breached glass bubbles form the porous structure, the porous structure comprising at least 10 vol % to 15 vol % MgO and glass bubbles comprising 10 wt % to 20 wt % Na₂O. According to some embodiments the bonded, breached glass bubbles form the porous structure, the porous structure comprising at least 10 vol % to 15 vol % MgO and glass bubbles comprising 20 to 30 wt % Na₂O.

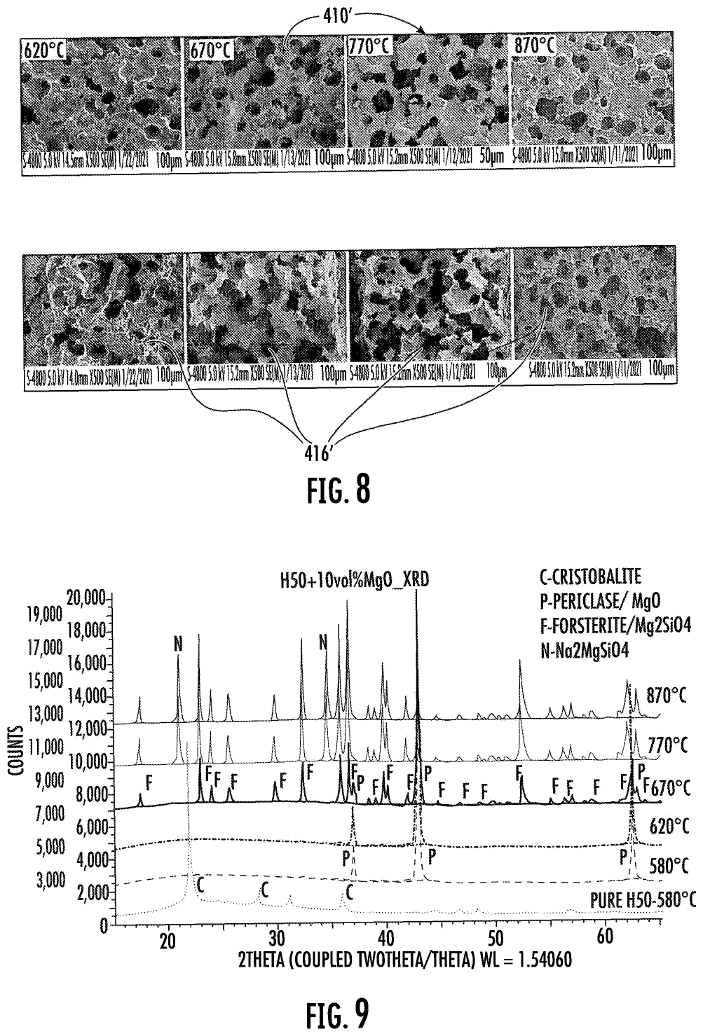

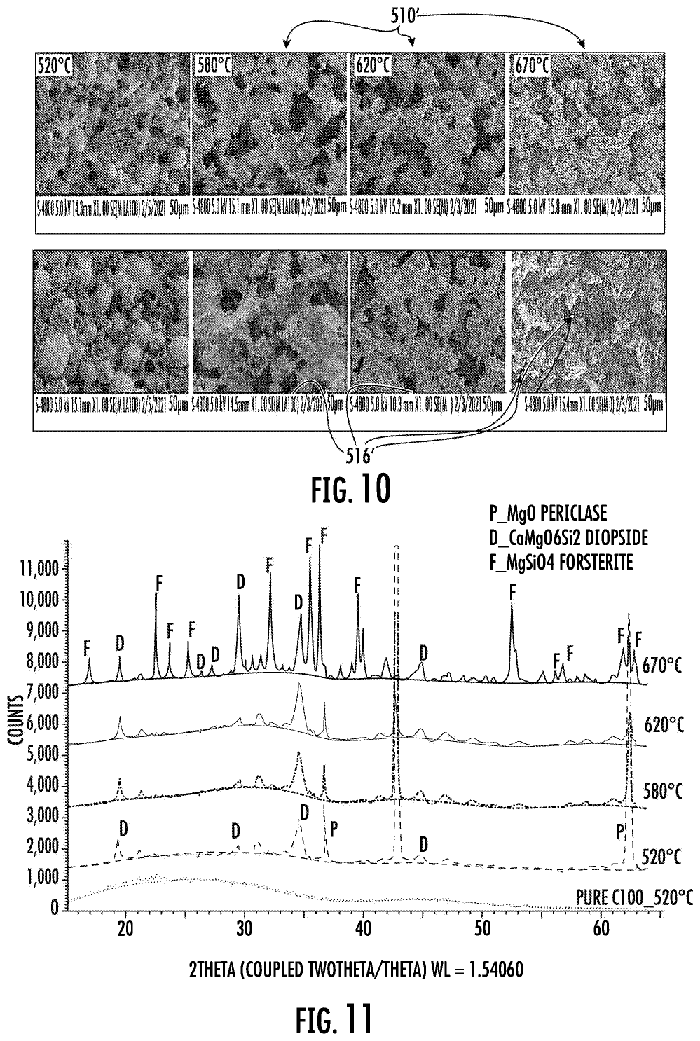

Referring now to FIGS. 5, 8, and 10, structures 410, 510 are related to the green (unfired) structures 410, 510. More specifically, structure 410 of FIG. 8 may be an exterior or an interior wall of a porous structure, and structure 510′ of FIG. 10 may also be an interior or exterior wall or web of a porous structure, such as a honeycomb as shown in FIG. 1. However, structures 410, 510 are not “green” structures. Instead, shells or husks of glass bubbles 412′, 512 are bonded to one another and the glass bubbles 412, 512 are breached, where interior volumes of the glass bubbles 412′, 512′ are exposed and spaces between the glass bubbles 412, 512′ are open and interconnected with one another, forming cavities 416′, 516′ (tortuous pathways) extending throughout and to surfaces of the structures 410′, 510′. According to an exemplary embodiment, glass bubbles with high crystallinity at softening temperatures of the glass bubbles, such as glass bubbles including more than 50% SiO₂ and/or CaSiO₃, etc. by weight, facilitate transformation processes from internal porosity to open connected porosity, as discussed below. Exemplary glass composition constituents include (in wt %) more than 44% SiO₂, at least 0.2% CaO, less than 1% and at least some Al₂O₃, 0 to 0.1% Fe₂O₃, and greater than 7.3 wt % (for example greater than 8%, greater than 8.5%, or greater than 9%, greater than 9.5%, or greater than 10%) Na₂O. In some embodiments the amount of Na₂O in the glass bobbles is 12% or greater, 15% or greater, 18% or greater, 20% or greater, 25 or greater, or 30%, or therebetween (e.g., 8%-30%, 8%-25%, 8-20%, 9.5% to 25%, or 9.5% to 20%). In some embodiments the glass bubbles contain MgO. Some exemplary compositions for the glass bubbles are provided in Table 1.

TABLE 1
Glass bubble composition (wt %) before
heating/firing of the porous structure.

| | A | B | C | D | E | F | G |
|---|---|---|---|---|---|---|---|
| SiO₂ | 78.3 | 78.3 | 73.7 | 71.8 | 75.3 | 44.9 | 67.7 |
| CaO | 7.9 | 7.7 | 6.9 | 7.7 | 0.2 | 4.5 | 6.6 |
| B₂O₃ | 5.6 | 6.4 | 9.7 | 12.0 | 2.4 | 26.7 | 13.3 |
| Al₂O₃ | 0.4 | 0.4 | 0.4 | 0.5 | 0.3 | 0.4 | 0.5 |
| Fe₂O₃ | 0.0 | 0.1 | 0.1 | 0.0 | 0.0 | 0.0 | 0.0 |
| Na₂O | 7.0 | 6.5 | 8.3 | 7.3 | 18.7 | 15.8 | 9.9 |
| K₂O | 0.0 | N.D. | 0.0 | 0.0 | 0.0 | 0.0 | 0.1 |
| MgO | 0.5 | 0.4 | 0.2 | 0.2 | 0.0 | 0.1 | 0.1 |
| Additional | 0.2 | 0.1 | 0.6 | 0.4 | 2.9 | 7.4 | 1.8 |
| components* | | | | | | | |

*In Table 1 embodiments additional components may include additional Na₂O and/or MgO, ash, talk, and/or volatile components that will be lost when heated as described below. More specifically, FIG. 5 shows morphology transformation of HGMS (honeycomb made with hollow glass microspheres) during heat treatment of glass micro-bubbles corresponding to glass example A containing only 7 wt % N₂O (i.e., less than 7.3 wt % N₂O), when Mg oxide was not added to the batch. FIG. 5 illustrates glass bubble morphology transformation over different heating temperatures. As shown in FIG. 5, when the glass micro-bubbles were heated to a temperature of 670° C., most of the glass micro-bubbles appear fully intact. As the peak temperature increased to at about 770° C., some ruptured micro-bubbles and some crystallization was observed, with shrinkage parameter s increasing to 12.6%. As the temperature continued to increase, a larger amount of micro-bubbles ruptured (opened). At about 900° C. the ruptured micro-bubbles formed connected pores, resulting in porosity of the structure 410′ of about between 57% and 75%. When the peak temperature was increased to about 1000° C., more micro-bubbles ruptured, and the resulting structure 410′ highest porosity of 77-80% was achieved at the temperature about 1020° C. For example, FIGS. 5 and 6 illustrate that when microbubble composition included at 7 wt % Na₂ O we were able to achieve a porosity of at least 67% (for example between about 67.5% and about 75% at firing temperatures between 770° C. and 1000° C.). At higher temperatures (e.g. >1100° C.) the resulting glass structure began to condense, shrinking further and forming a dense body while losing much of its porosity. At the temperatures above 900° C. we observed significant shrinkage, as measured by a parameter s, while the minimal shrinkage was observed when the temperatures were below 770° C. (e.g. between about 670° C. and 770° C.). That is, in this example, we observed significant shrinkage (as evident in increase value of the parameter s) when the peak temperature was increased to 770° C. and beyond. FIG. 5 also illustrates that when the peak temperature was increased to 1170° C., the resulting structure formed a dense body with fewer pores and the walls between the pores thickened, due to the softening of the molten phase, and the porosity p of the glass structure was reduced to about 51%.

FIG. 6 further illustrates change of the microstructures shown in FIG. 5 versus temperature. As stated above, in this example, no source of Mg was added to the batch. More specifically, FIG. 6 depicts firing temperature impact on honeycomb morphology transformation and indicates the presence of crystal phases. It illustrates that at the peak temperature of 670° C. the porosity of the structure 410′ was about 56.3%, and the median pore size was 7 μm. At 770° C., more micro-bubbles opened up, and porosity, p, increased to about 67.8%. At the temperature of 770° C. the median pore size was 7.3 μm, but the shrinkage s of the resultant porous structure 410′ was increased to 12.6%.

In this embodiment, the porosity p continued to increase between 800° C. and 1000° C., as more microbubbles opened. At a temperature of 1020° C., microbubbles bubble opened thoroughly, the porosity reached its highest of 77.3%, and the median pore size increased to 22.7 μm. However, although at this the peak temperature (1020° C.) the porosity was high, the shrinkage, s, was also high, i.e., about 18.5%. Finally, when the temperature was increased to 1170° C., the densification caused the porosity to be reduced to 51.1%. We observed the increased trend toward more crystallization as the peak heating temperatures increased from 770° C. to 1000° C., and decreases in porosity during the densification that occurred at temperatures at above 1020° C. Also, when the peak temperature was increased to 1170° C. the shrinkage s increased to about 28.7%, which is undesirable.

However, we discovered that the addition of Mg source to the batch containing the micro-bubbles (such that the resulting structure has at least 10 vol % of MgO), surprisingly results in reduction of the shrinking of the structure 410′, and in increase in structure's porosity, while enabling glass bubbles to sinter and rupture at lower peak temperatures (e.g., <900° C., ≤870° C., ≤850° C., or ≤800° C.). The low peak temperature help reduce shrinkage s to below 10%, and even <5%, while maintaining high porosity of >50%, >55%, or even greater than 60%.

More specifically, as the amount of Na₂O within the glass micro-bubbles increased, for example to 9.5 wt % or more (e.g., to 10 wt % or more, to 12 wt % or more, to 15 wt % or more, or to 20 wt % or more), the glass micro-babbles based structures softened at progressively lower temperatures. However, in absence of significant amount of magnesium (Mg), the softened glass quickly melted and formed a densified body with relatively low porosity, which is undesirable. For example, without a significant MgO presence in the batch (<1 wt % MgO, or <2 wt % MgO), when the amount of Na₂O within the glass micro-bubbles increased to 10 wt % and then to 20 wt %, the glass melted at progressively lower temperatures, forming a densified body with low or no porosity.

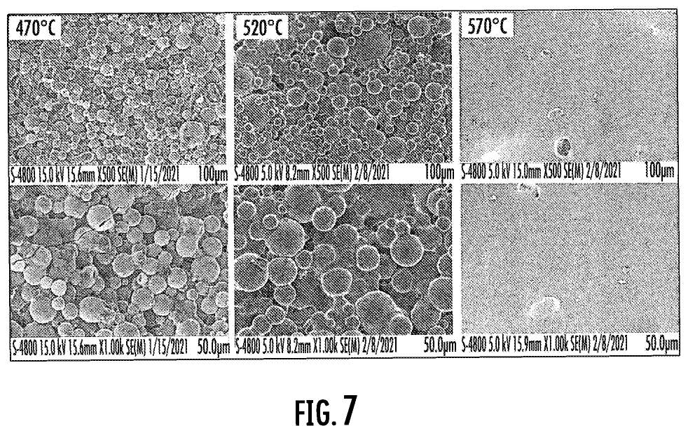

For example, FIG. 7 illustrates comparative HGMS morphology transformation when the micro-bubbles contain higher amounts of sodium (Example E glass composition, 18.7 wt % Na₂O) and essentially no Mg. As peak temperature increased, HGMS glass structure softened at 470° C., the softening lasted to about 520° C. and then formed a more liquid phase. Between the temperatures of 520° C. and 570° C. glass micro-bubbles quickly melted and the resultant structure lost its porosity and became a densified body, which is undesirable. For example, after the glass structure was heated to the peak temperature 570° C., we observed no pores on the surface of this densified body. Furthermore, no crystallization was detected. This study indicated the high amount of sodium in glass caused glass melting at lower temperatures, shrinkage of the glass based structure, and the undesirable minimization or elimination of the crystallization and porosity in the resulting structure.

We discovered that addition of a magnesium source containing a significant amount of magnesium to the batch containing glass micro-bubbles that comprise higher sodium amounts surprisingly resulted in minimization of structural shrinking and large increase in structure's porosity. For example, when the micro-bubbles contain higher Na₂O (e.g., at least 7.3 wt %, at least 8 wt %, at least 9 wt %, at least 9.5 wt %, or greater than 10 wt %, or greater than 12 wt %, or greater than 15 wt %) the addition of at least 10 vol % of magnesia to the structure greatly enhanced the porosity of the resulting structure, while keeping the peak firing temperature low (e.g., at or below 900° C., or at ≤850° C., or at ≤800° C.). In some embodiments the peak firing temperature is between 500° C. and 900° C., for example: between 600° C. and 900° C., between 500° C. and 850° C., between 600° C. and 850° C., between 600° C. and 750° C., between 500° C. and 750° C., or between 600° C. and 700° C. The porosity of the resulting structures is, for example, at least 60%.

Table 2, below, shows batch composition with 10 vol % (i.e., 44.3 wt %) to 15 vol % (i.e., 55.8 wt %) addition of MgO, that was used to form a porous structure (200/8 honeycomb) with 60-78% porosity. Pore size and its size distribution were different under different heating temperatures between 620-870° C. More specifically, Table 2 illustrates that when the glass micro-bubbles corresponded to Example E glass composition (18.7 wt % Na₂O), the addition of 10 vol % of MgO (i.e., 44.3 wt % MgO) to the batch resulted in 69% porosity when the glass batch was fired at a peak temperature of 620° C. and resulted in 63% porosity when the glass bubble containing structure was fired (heated) at the peak temperature of 870° C. Furthermore, Table 2 also illustrates that the addition of 15 vol % (55.8 wt %) of MgO to the batch (instead of 10 vol % of MgO) resulted in about 76-78% porosity when the glass batch was fired at a peak heating temperatures between 620° C. and 670° C.

TABLE 2
Batch composition for high porosity honeycomb comprising micro-bubbles with glass E
composition, and the resultant structure porosity after firing at peak temperatures.

| | H50 | A4M | MgO | Oil | DIW | * MgO | Firing (peak)temp- | | | | | |
|---|---|---|---|---|---|---|---|---|---|---|---|---|
| Green batch | (g) | (g) | (g) | (g) | (g) | wt % | dwell time | Porosity | d₁₀ | d₅₀ | d₉₀ | d_{f} |
| Example E | 90.1 | 25 | 71.7 | 4 | 115 | 44.3% | 620° C.-4 h | 69.0% | 5.5 | 18.8 | 32.2 | 0.71 |
| glass bubbles + | | | | | | | 670° C.-4 h | 67.5% | 11.9 | 21.6 | 38.1 | 0.45 |
| 10 vol % MgO | | | | | | | 770° C.-4 h | 61.2% | 13.2 | 17.8 | 37.1 | 0.26 |
| | | | | | | | 870° C.-4 h | 63.1% | 13.9 | 19.2 | 38.1 | 0.27 |
| Example E | 85.1 | 25 | 107.5 | 4 | 120 | 55.8% | 620° C.-4 h | 75.9% | 0.4 | 13.9 | 18.2 | 0.97 |
| glass bubbles + | | | | | | | 670° C.-4 h | 77.5% | 9.1 | 15.7 | 20.2 | 0.42 |
| 15 vol % MgO | | | | | | | 770° C.-4 h | 77.1% | 8.5 | 15.2 | 20.2 | 0.44 |
| | | | | | | | 870° C.-4 h | 77.7% | 8.0 | 14.8 | 20.2 | 0.46 |

* Note:
MgO wt % in the batch = MgO (g)/[H50 (g) + MgO (g)], measured before firing, and excludes organic materials

FIG. 8 illustrates honeycomb morphology transformation of one exemplary embodiment. In this embodiment the batch contains 10 vol % MgO (i.e., 44.3 wt % MgO), and glass micro-bubbles that comprise Example E glass composition (18.7 wt % Na₂O). The addition of Mg to the batch facilitated crystallization and opening/rupture of a large amount of micro-bubbles at temperatures between 620° C. and 770° C., while minimizing shrinkage of the resulting structures when subjecting the batch to higher temperatures (e.g., at >870° C.). FIG. 9 illustrates XRD (x-ray diffraction) results indicating that the highly porous substrate structures of FIG. 8 comprise crystal phases including MgO, Na₂MgSiO₄ and forsterite.

In another embodiment, the addition of 15 vol % of MgO (i.e., 38.7 wt % of MgO) to the batch containing micro-bubbles with glass composition comprising 15.8 wt % Na₂O resulted in greater than 60% porosity when the glass batch was fired at a peak heating temperatures between 550° C. and 700° C. For example, Table 3 and FIG. 10 illustrate that when the glass micro-bubbles corresponded to Example F glass composition (15.8 wt % Na₂O) were used in the batch, the addition of 15 vol % of MgO (38.7 wt % of MgO) to the batch resulted in 65.3% porosity when the batch was fired at a peak temperature of 580° C. Table 3 also illustrates that the addition of 15 vol % of MgO to this batch resulted in porous structure with 66% porosity when the batch was fired at a peak temperature of 620° C., and about 65% porosity when the batch was fired at a peak temperature of 670° C. For this firing temperature the porous structure shrinkage parameter, s, was <12%.

TABLE 3
Batch composition comprising micro-bubbles (composition F containing 30% Na₂O, suitable for
high porosity honeycomb., and structure porosity after firing at various peak temperatures.

| | | 9% CMC | | | | | Firing | | | | | |
|---|---|---|---|---|---|---|---|---|---|---|---|---|
| Sample | | solution | | | DIW | MgO | (peak | | | | | |
| ID | C100(g) | (g) | MgO(g) | Oil(g) | (g) | wt % | temperature) | Porosity | d10 | d50 | d90 | df |
| Example | 170 | 190 | 107.4 | 8 | 40 | 38.7% | 580° C.-4 h | 65.3% | 10.0 | 14.2 | 18.2 | 0.29 |
| F glass + | | | | | | | 620° C.-4 h | 66.0% | 10.7 | 14.7 | 19.1 | 10.27 |
| vol % MgO | | | | | | | 670° C.-4 h | 64.8% | 5.0 | 11.5 | 19.1 | 0.57 |

FIG. 10 shows honeycomb morphology transformation when the batch that contains 15 vol % MgO and glass micro-bubbles Example F glass composition (30 wt % Na₂O) is fired at different temperatures. More specifically, FIG. 10 illustrates that addition of a large amount of Mg to the batch facilitated crystallization and opening/rupture of a large amount of micro-bubbles at temperatures between 520° C. and 670° C. It also minimizes shrinkage of the resulting structures when the batch is subjected to higher temperatures. FIG. 11 illustrates XRD results indicating that the highly porous substrate structure that resulted from firing the batch containing micro-bubbles comprising 15 vol % MgO and micro-bubbles with Example F glass composition comprises crystal phases including MgO, diopside and forsterite.

According to some embodiments a porous structure comprises:
a plurality of glass bubbles;
wherein the glass bubbles are sintered to one another such that adjoining glass bubbles are physically bonded directly to one another;
wherein more than 50% of the glass bubbles are breached;
wherein voids defined within individual breached glass bubbles open into one another to form cavities that extend through the porous structure and to surfaces thereof; and
the porous structure has at least 50% porosity in terms of volume and comprises at least 8 wt % Na₂O and least 10 vol % MgO.

According to some embodiments a porous structure comprises at least 8.3 wt % Na₂O and least 10 vol % MgO. According to some embodiments a porous structure comprises at least 8.3 wt % Na₂O and 10 vol % to 60 wt % MgO. According to some embodiments a porous structure comprises at least 8.5 wt % Na₂O and 10 vol % to 60 wt % MgO MgO.

Table 4 below summarizes compositions of various exemplary embodiments of porusd structures.

| | | | Porous structure After | |
|---|---|---|---|---|
| | | | Firing (calculated, | |
| | | | assuming no | |
| | | | volatization of | |
| | Glass Composition | | inorganic species) | |
| Batch composition | Na₂O wt % | MgO wt % | Na₂O wt % | MgO wt % |
| Example E glass | 18.7 | 0.04 | 10.4 | 44.3 |
| comsposition + 10 vol % MgO | | | | |
| Example E glass | 18.7 | 0.04 | 8.3 | 55.8 |
| composition + 15 vol % MgO | | | | |
| Example F glass | 15.8 | 0.07 | 9.7 | 38.8 |
| composition + 15 vol % MgO | | | | |

Referring to FIGS. 5, 8, and 10, internal walls formed between pores within the porous structures may be particularly thin, such as less than 1 millimeter (mm) in thickness, such as less than 500 micrometers (μm), such as less than 100 μm, such as less than 50 μm, such as less than 10 μm, such as less than 5 μm in some contemplated embodiments, such as where particularly small glass bubbles are used, as discussed below

As may be seen in FIGS. 8 and 10, at least in some embodiments, glass of the glass bubbles 412′, 512′ devitrifies and forms crystals. In FIGS. 5, 8, and 10, the devitrified glass appears light gray. Gradually heating, and dwelling, as disclosed herein, may facilitate crystal growth, which may toughen the resulting structures 410′, 510′. While green material may include amorphous glass bubbles, the processed structures, after firing, may be a glass-ceramics with crystallinity over 45% by weight (e.g., at least 50% wt; e.g., 64% wt crystallinity). In some embodiments, the porous structure (after firing), in terms of weight, consists mostly of glass (including devitrified glass), such as consisting at least 90% of glass. In some such embodiments, the porous structure consists of less than 55% of amorphous phase by weight.

The cavities 416′, 516′ formed by the breached glass bubbles 412′, 512′ and/or voids left behind from burned-out binder (see binder 414, 514 of FIGS. 4-5) may lead to particularly high porosity of resulting structures 410′, 510′. Applicants believe that the presently disclosed technology provides for high porosity, such as at least 40%, at least 50%, at least 55%, at least 60%, at least 65%, at least 70%, at least 80% by volume (see ASTM D6761-07). According to some exemplary embodiments, the porous structures 0 have at least 65% and no more than 85% porosity in terms of volume.

While FIGS. 5, 8, and 10 show microstructure and surface features, according to at least some exemplary embodiments, porous structures may have a total volume, within outer surfaces thereof (e.g., outer surface having the openings on outer surface 214 of at least 1 cubic centimeter (cm³), such as at least 2 cm³, such as at least 10 cm³, such as at least 50 cm³, and/or no more than 2000 cm³, such as no more than 1000 cm³; but in other embodiments, the volume may be much larger, such as for large frontal area filters.

In contemplated embodiments, processes and technology disclosed herein are used with honeycomb filters, such as diesel engine particulate filters. Glass bubbles are selected with sufficient crush strength and small enough geometry to facilitate extrusion of honeycomb bodies having at least 50 cells per square inch, such as at least 100 cells per square inch, such as at least 200 cells per square inch, such as at least 300 cells per square inch, and/or web thickness of no more than 10 mils (i.e. thousandths of an inch), such as no more than 8 mils, such as no more than 7 mils, such as no more than 6 mils, such as no more than 5 mils, such as for example cell geometries at least as dense as, no denser than, or about 200/8 cells per square inch over web thickness in mils, 400/7, 400/6, 400/5, 400/4, 400/3, 400/2, 300/7, 300/6, 300/5, 300/4, 300/3, 300/2, 200/7, 200/6, 200/5, 200/4, 100/8, 100/7, 100/6, 100/5, 50/8, 50/7, 50/6, etc.

At least some such embodiments have a cylindrical geometry, with a diameter of at least 4 inches, such as at least 6 inches, such as at least 8 inches, such as at least 12 inches, such as at least 24 inches, and/or no more than 64 inches, such as no more than 36 inches. Other such embodiments have a generally square, rectangular, or other polygonal geometry in cross-section, with sides of at least 4 inches, such as at least 6 inches, such as at least 8 inches, such as at least 12 inches, such as at least 24 inches, and/or no more than 64 inches, such as no more than 36 inches. Other contemplated embodiments have other sizes or shapes. Such geometries may facilitate low pressure drop, high dust loading, and high filtration efficiency.

According to some embodiments, a porous structure comprises:
a plurality of glass bubbles comprising at least 10 wt % Na₂O; wherein: (i) the glass bubbles are sintered to one another such that adjoining glass bubbles are physically bonded directly to one another; (ii) more than 50% of the glass bubbles are breached; (iii) voids defined within individual breached glass bubbles open into one another to form cavities that extend through the porous structure and to surfaces thereof; and (iv) the porous structure has at least 50% porosity in terms of volume and comprises at least 10 vol % MgO.

According to some embodiments, the porous structure comprises at least 20 wt % of Na₂O; and at least 10 vol % of MgO, for example 15 wt % to 30 wt % Na₂O, and 10 vol % to 15 vol % MgO. According to some embodiments of the porous structure at least 50% of the glass bubbles are breached. According to some embodiments of the porous structure at least 60% of the glass bubbles are breached. According to some embodiments of the porous structure at least 50% of the glass bubbles are breached. For example, in some embodiments than 60% of the glass bubbles are breached, and the porous structure comprises at least 20 wt % Na₂O and at least 10 vol % of MgO.

According to some embodiments, a porous structure comprises: a plurality of glass bubbles wherein: (i) the glass bubbles are sintered to one another such that adjoining glass bubbles are physically bonded directly to one another; (ii) more than 50% of the glass bubbles are breached; (iii) voids defined within individual breached glass bubbles open into one another to form cavities that extend through the porous structure and to surfaces thereof; and (iv) the porous structure has at least 50% porosity in terms of volume and comprises at least 10 vol % MgO. According to some embodiments, the porous structure comprises at least 8.5 wt % Na₂O and at least 10 wt % of MgO. According to some embodiments, the porous structure comprises at least 8.3 wt % Na₂O and at least 10 wt % of MgO. According to some embodiments, the porous structure comprises at least 8.3 wt % Na₂O and to 60 wt % of MgO.

According to some embodiments, the porous structure comprises at least 55% porosity in terms of volume, for example at least 60%, at least 65%, at least 70%, at least 75%, or at least 80% porosity in terms of volume.

For example, the porous structure may have 60% to 95% porosity in terms of volume, for example least 65% and no more than 85%.

According to some embodiments of the porous structure at least some glass of the glass bubbles is devitrified such that the glass comprises crystals. According to some embodiments of the porous structure, in terms of weight, the porous structure comprises mostly of glass, for example at least 80 or 90% of glass in terms of weight. In some embodiments the porous structure comprises less than 75% of amorphous-phase glass.

According to some embodiments the porous structure has a cellular honeycomb geometry with a web thickness of no more than 10 mils and a cell density of no more than 400 cells per square inch.

In some embodiments, a method of making a porous structure, which is configured for use in a filter, includes steps of breaching a plurality of glass bubbles (e.g., at least 100, at least 1000, at least 10,000 glass bubbles) and bonding the plurality of glass bubbles to one another at relatively low sintering temperatures, e.g., at 870° C. or less, at 850° C. or less, preferably at 800° C. or less, (e.g., at 750° C. or less, or between 500° C. to 725° C., 500° C. to 700° C., 550° C. to 725° C., or even 550° C. to 700° C.). In aggregate, the bonded, breached glass bubbles form the porous structure, where voids within individual breached glass bubbles open into one another to form cavities that extend through the porous structure and to surfaces thereof. In some such embodiments, the breaching includes expanding gasses within the glass bubbles to rupture the glass bubbles. In other such embodiments, the breaching includes devitrification of glass of the glass bubbles, where softening and movement of amorphous glass relative to the devitrified glass ruptures the glass bubbles. In other such embodiments, the method includes a step of heating the plurality of glass bubbles to at least a softening temperature of amorphous glass of the glass bubbles. The heating may be such that adjoining glass bubbles sinter to one another at sintering temperatures of 500° C. to 770° C. (e.g. 550° C. to 750° C., or 550° C. to 700° C.). The breaching may occur concurrently during the heating. In some embodiments, the method includes a step of cooling the plurality of glass bubbles with adjoining glass bubbles physically bonded directly to one another. Timing and temperatures of the heating and/or cooling may devitrify at least some of the glass of the glass bubbles so that crystals form. Applicants believe that devitrification may aid in rupture of the glass bubbles, such as by limiting shrinkage of glass bubbles under negative core pressures.

In some such embodiments, prior to the heating step, the method of making a porous structure includes a step of extruding green material that includes the glass bubbles and an organic binder. Most of the glass bubbles survive the extruding without fracturing. In some such embodiments, heating burns out or chemically changes most of the organic binder in terms of weight from the porous structure. During the heating, the glass bubbles are heated at a temperature increased from ambient temperature to a first temperature with a first dwell time, then the temperature is increased from the first temperature to a second temperature with a second dwell time. The first temperature may be in a range from 300° C. to 400° C. and the first dwell time may be in a range from 1 to 10 hours. In some such embodiments, the second temperature may be between 550° C. and 900° C. (e.g., 550° C. to 700° C.), and the second dwell time is from 1 to 10 hours (e.g., 4-6 hours). In at least some of those embodiments, the second temperature is above 400° C. and below a softening point of amorphous glass of the glass bubbles, and the second dwell time is from 1 to 10 hours (e.g., 1 to 3 hours).

According to some embodiments, a firing process to breach/open the glass bubbles comprising heating glass bubbles. During heating, the glass bubbles may be heated from ambient temperature to a first temperature(s) (e.g., fixed temperature and/or temperatures in a limited range) with a first dwell time, such as where the first temperature(s) is at least 200° C., such as from 300° C. to 400° C. (to burn out binder and other inorganic components) and/or where the first dwell time is at least 1 minute, such as from 1 hour to 10 hours. In some such embodiments, the temperature is then increased from the first temperature to a second temperature(s) with a second dwell time (which helps to facilitate crystallization), such as where the second temperature(s) is greater than 400° C., such as from 500° C. to 750° C., and where the second dwell time is also at least 1 minute, such as from 1 to 10 hours.

According to some embodiments, a method of making a porous structure configured for use in a particulate filter comprises:
adding a source Mg to a plurality of glass bubbles comprising Na₂O;
heating and bonding the plurality of glass bubbles to one another, wherein the glass bubbles have a D50 particle size of at least 1 micrometer but no more than 100 micrometers, and wherein the plurality comprises at least 1000 of the glass bubbles; and
breaching at least some of the glass bubbles at a temperature between 500° C. and 800° C. (e.g., between 60° and 770° C., or between 60° and 750° C.);
wherein, in aggregate, the bonded, breached glass bubbles form the porous structure, the porous structure comprising at least 10 wt % Na₂O and at least 10 vol % MgO, and wherein voids within individual breached glass bubbles open into one another to form cavities that extend through the porous structure and to surfaces thereof.

According to some embodiments of the method, the heating step is performed at a peak temperature that is less than 900° C.

According to some embodiments a method of making a porous structure configured for use in a particulate filter comprises:
adding a source MgO to a plurality of glass bubbles comprising Na₂O;
heating and bonding the plurality of glass bubbles to one another, wherein the glass bubbles have a D50 particle size of at least 1 micrometer but no more than 100 micrometers, and wherein the plurality comprises at least 1000 of the glass bubbles; and
breaching at least 50% of the glass bubbles (e.g., 60%-99%) at a temperature between 500° C. and 800° C. (e.g., between 600° cand 770° C.)
wherein, in aggregate, the bonded, breached glass bubbles form the porous structure, the porous structure comprising at least 10 vol % MgO, and glass bubbles comprising glass haing at least 7.3 wt % Na₂O (e.g., at least 8 wt % Na₂O, at least 9 wt % Na₂O, or at least 10 wt % Na₂O; wherein voids within individual breached glass bubbles open into one another to form cavities that extend through the porous structure and to surfaces thereof.

According to some embodiments a method of making a porous structure configured for use in a particulate filter comprises:
adding a source MgO to a plurality of glass bubbles comprising Na₂O;
heating and bonding the plurality of glass bubbles to one another, wherein the glass bubbles have a D50 particle size of at least 1 micrometer but no more than 100 micrometers, and wherein the plurality comprises at least 1000 of the glass bubbles; and
breaching at least 50% of the glass bubbles (e.g., 60%-99%) at a temperature between 500° C. and 800° C.,
wherein, in aggregate, the bonded, breached glass bubbles form the porous structure, the porous structure comprising: (i) at least 15 wt % Na₂O and (ii) at least 10 vol % MgO, and wherein voids within individual breached glass bubbles open into one another to form cavities that extend through the porous structure and to surfaces thereof.

According to some embodiments the breaching step includes breaching at least 50% of the glass bubbles at a temperature between 500° C. and 870° C., between 500° C. and 8000° C., between 500° C. and 770° C., between 600° C. and 770° C., or between 600° C. and 750° C. According to some embodiment the breaching step includes breaching at least 60% of the glass bubbles at a temperature between 500° C. and 770° C., or between 60° and 750° C. According to some embodiment the breaching step includes breaching between 60% to 99.5% of the glass bubbles at a temperature between 500° C. and 770° C., or between 60° and 750° C.

According to some embodiments of method of making a porous structure the bonded, breached glass bubbles form the porous structure, and the porous structure comprises 10 vol % to 15 vol % MgO and glass bubbles comprising at least 8.5 wt % Na₂O, for example to 10 to 15 vol % MgO and glass bubbles comprising 9.5 wt % to 30 wt % Na₂O.

According to some embodiments of method of making a porous structure the bonded, breached glass bubbles form the porous structure, and the porous structure comprises 10 wt % to 60 wt % MgO and at least 8 wt % Na₂O (for example 8.5 wt % to 30 wt % Na₂O).

According to some embodiments method of making a porous structure further comprises devitrifying at least some glass of the glass bubbles to form crystals. According to some embodiments the porous structure has at least 50% crystallinity. According to some embodiments the porous structure has at least 60% crystallinity. According to some embodiments the porous structure has 60% to 95%. According to some embodiments the breaching step includes flowing amorphous glass of the glass bubbles relative to the crystals.

Construction and arrangements of the porous structures, assemblies, and structures, as shown in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments.

Other substitutions, modifications, changes and omissions may also be made in the design, operating conditions and arrangement of the various exemplary embodiments without departing from the scope of the present inventive technology.

The invention claimed is:

1. A porous structure, comprising:
a plurality of glass bubbles comprising at least 7.3 wt % Na₂O;
wherein the glass bubbles are sintered to one another such that adjoining glass bubbles are physically bonded directly to one another;
wherein more than 50% of the glass bubbles are breached;
wherein voids defined within individual breached glass bubbles open into one another to form cavities that extend through the porous structure and to surfaces thereof; and
wherein the porous structure has at least 50% porosity in terms of volume and comprises at least 10 vol % MgO.

2. The porous structure of claim 1, comprising:
(i) at least 10 vol % of MgO, and glass bubbles comprising glass with at least 10 wt % Na₂O; or (ii) glass bubbles comprising glass with 15 wt % to 30 wt % Na₂O, said porous structure comprising 10 vol % to 15 vol % MgO.

3. (canceled)

4. (canceled)

5. The porous structure of claim 1, comprising glass comprising 10 wt % to 20 wt % of Na₂O; said porous structure comprising 10 vol % to 15 vol % of MgO.

6. The porous structure according to claim 1 wherein more than 60% of the glass bubbles are breached.

7. The porous structure according to claim 1, wherein the porous structure has at least 55% porosity in terms of volume.

8. (canceled)

9. (canceled)

10. The porous structure according to claim 7, wherein the porous structure has at least 75% porosity in terms of volume.

11. The porous structure according to claim 1, wherein the porous structure has at least 60% to 95% porosity in terms of volume.

12. (canceled)

13. The porous structure of claim 1, wherein at least some glass of the glass bubbles is devitrified such that the glass comprises crystals.

14. The porous structure of claim 1, wherein, in terms of weight, the porous structure comprises mostly of glass.

15. The porous structure of claim 1, wherein, in terms of weight, the porous structure: (i) comprises >50% of glass; or (ii) is >50% crystalline.

16. (canceled)

17. The porous structure of claim 1, wherein, in terms of weight the porous structure comprises: (i) at least 90% of glass, or (ii) less than 75% of amorphous-phase glass.

18. (canceled)

19. The porous structure of claim 1, wherein the porous structure has a cellular honeycomb geometry with a web thickness of no more than 10 mils and a cell density of no more than 400 cells per square inch.

20. A method of making a porous structure configured for use in a particulate filter, comprising:
adding a source Mg to a plurality of glass bubbles comprising Na₂O;
heating and bonding the plurality of glass bubbles to one another, wherein the glass bubbles have a D50 particle size of at least 1 micrometer but no more than 100 micrometers, and wherein the plurality comprises at least 1000 of the glass bubbles; and
breaching at least some of the glass bubbles at a temperature between 500° C. and 800° C.;
wherein, in aggregate, the bonded, breached glass bubbles form the porous structure, the porous structure comprising at least 7.3 wt % Na₂O and at least 10 wt % MgO, and wherein voids within individual breached glass bubbles open into one another to form cavities that extend through the porous structure and to surfaces thereof.

21. The method of making a porous structure configured for use in a particulate filter according to claim 20, wherein the heating step is performed at a peak temperature that is less than 900° C.

22. A method of making a porous structure configured for use in a particulate filter according to claim 20, comprising:
breaching at least 50% of the glass bubbles at a temperature between 500° C. and 800° C.;
wherein, the porous structure comprising at least 15 wt % Na₂O and at least 10 wt % MgO.

23. (canceled)

24. The method of making a porous structure configured for use in a particulate filter according to claim 20, wherein, in aggregate, the bonded, breached glass bubbles form the porous structure, the porous structure comprising 20 wt % to 30 wt % Na₂O and 10 wt % to 15 wt % MgO.

25. The method of claim 20 or 22, further comprising devitrifying at least some glass of the glass bubbles to form crystals.

26. The method of claim 22, wherein the breaching includes flowing amorphous glass of the glass bubbles relative to the crystals.

27. The method of claim 22, wherein the heating is such that adjoining glass bubbles sinter to one another.

28. (canceled)

29. The method of claim 27, further comprising cooling the plurality of glass bubbles with the adjoining, breached glass bubbles physically bonded directly to one another.

30. The method of claim 24, further comprising, prior to the heating, extruding green material comprising the glass bubbles and an organic binder, wherein most of the glass bubbles survive the extruding without fracturing.

31. The method of claim 27, wherein the extruding comprises extruding thousands of the glass bubbles coupled to one another with the organic binder.

32. (canceled)

33. The porous structure of claim according to claim 19 wherein glass bubbles have a D50 particle size of at least 1 micrometer but no more than 100 micrometers.

34. (canceled)

35. (canceled)
